(19) United States
(12) Patent Application Publication
(10) Pub. No.: US 2009/0219136 A1
(43) Pub. Date: Sep. 3, 2009

(54) Secure Document, In Particular Electronic Passport With Enhanced Security

(76) Inventors: Olivier Brunet, Marseille (FR); Olivier Artigue, Trets (FR); Henri Boccia, Belcodene (FR); Philippe Patrice, Marseille (FR); Ivan Peytavin, Aix En Provence (FR)

Correspondence Address: BUCHANAN, INGERSOLL & ROONEY PC, POST OFFICE BOX 1404, ALEXANDRIA, VA, 22313-1404, US

(21) Appl. No.: 12/083,012

(22) PCT Filed: Aug. 3, 2006
(86) PCT No.: PCT/FR2006/001920

§ 371 Date: Apr. 21, 2009

(51) Int. Cl. H04B 7/00; G06K 19/077

(52) U.S. Cl. 340/5.86; 235/492

(57) ABSTRACT

A secure document, in particular an electronic passport, includes a support equipped, on the one hand, with active security devices having a microcircuit connected to an antenna that can produce an electromagnetic response when it passes through the electromagnetic field of a contactless reader designed to query the identity document. The support is equipped, on the other hand, with passive security devices selected so as to have electrical characteristics, in particular inductive, capacitive and resistive, that are suitable for amplifying the electromagnetic response of the active security devices to make it go beyond a threshold that allows the secure document to be identified when it is placed in the electromagnetic field of a contactless reader. The invention has a useful application in national programs to issue passports with increased security.

The invention relates to a secure document, in particular such as an identity document or an electronic passport comprising a radiofrequency identification device. The invention also relates to an identification system using such secure documents.

For increased clarity and simplification of the rest of the account and description of the invention, secure documents as a whole will be referred to, regardless of whether or not they have the function of identifying a person or an object, by the term “secure document”. This term should not be taken in a restrictive manner as regards the shape of the document, which can furthermore be in the standard shape of a document, mainly on paper, or can consist of another type of secure portable object such as, for example, a memory card or a chip card.

In the state-of-the-art, there are known documents, which are more or less secure and can be used to identify persons or objects. Thus, documents such as identity cards, passports, grey cards for vehicle identification and driving licenses are known. These documents use certain secure devices such as “printed-patterns”, signature boxes designed to contain the holder's signature, or even holograms attached to the support of the document.

Among these known secure documents, there are therefore some that use a simple visual secure device, such as printed patterns on the document, as mentioned previously. This is still the case today with most of the passports in circulation in most countries. These printed patterns are simple, visual, passive identification devices. However, since they are difficult to copy, they certainly contribute to increasing the level of security compared with documents that do not include these security devices, even if the level of security achieved does not meet current requirements.

Thus, it is often the case that the paper used to manufacture identity documents is stolen by criminal networks and used to produce fake identity documents. It also happens that blank identity documents such as, for example, passports which have not yet been filled in with their holder's information, are stolen and then placed in circulation illegally at the request of individuals who need to have fake papers.

Due to these difficulties, another type of identity documents has begun to appear. These are identity documents possibly including, in addition to the printed security devices mentioned above, active identification means in the form of an electronic chip or microcircuit, which is solidly attached to the identity document, and the memory of which is loaded with information regarding the identity of the holder of the document. The information saved in the chip can be read by a dedicated reader and verified by a connection to a database, which can perform a series of crosschecks. Furthermore, the data read by the reader can be displayed on the screen of a reading system, at the request of a person in charge of the inspection, and it must match the information printed elsewhere on the document.

While there is no doubt that secure documents equipped with passive security devices such as printed patterns or active security devices such as a microcircuit that can store data are more resistant to forgery than documents with no electronic chip, they can still be falsified by determined networks with access to sufficient technical resources.

In fact, certain forgers are able to remove the microcircuit from a stolen original document and reinsert it in a fake identity document.

Thus, one of the drawbacks of currently known electronic passports is that it is possible in practice, by working with meticulous care and using the suitable tools, to remove the microcircuit that enables radiofrequency identification of the holder of the document, and to reinsert it in another passport or identity document, which constitutes a forgery. All this requires is to print the blank passport (containing the original printed patterns, among other devices) with the identification information of the person, as memorised in the chip.

When the document is inspected by the authorities, the identity document will pass the visual test, since it will have all the appearance of a valid identity document, and it will also pass the test conducted using a reader, since the latter will detect the presence of a microcircuit as well as any information that may be saved in its memory. In addition, in most cases the identification information stored in the memory and the identification information printed on the actual document will match, so that it is particularly difficult for the authorities to detect this type of forgery.

One aim of the invention is therefore to provide a secure document, in particular an electronic passport, which is even more secure than the secure documents known in the state-of-the-art.

Another aim of the invention is to provide a secure document equipped with an electronic circuit, which is capable of resisting abusive removal, or that is designed so that the removal of the microcircuit from the original document leaves the document completely unusable.

Another aim of the invention is to provide a secure document with a microcircuit which operates by contact and/or without contact, in particular by radiofrequency in the latter case, and that can only work with the contact or radiofrequency reader designed to interact with it when the secure document actually contains the original electronic microcircuit as well as the original passive security devices, so that tampering with either of the two types of security device renders the entire document ineffective, in other words, the planned readers cannot detect it as being a valid document.

For this purpose, the principle of the invention provides for intimately and functionally linking the visual or passive security devices of the secure document, such as the printed patterns or others, with the active security features included in a microelectronic circuit with which the document is equipped. The passive security devices are designed to be able to interact with the active security devices so that they become operational when the secure document is placed inside the electromagnetic field of a contactless reader. In this way, the security component based on the graphical security devices of the document and the secondary component based on the information stored in the microelectronic chip form an indivisible unit, which considerably increases the level of security of secure documents, in particular, secure identity documents.

In order to implement this new principle, the invention relates to a secure document, in particular an electronic passport, comprising a support equipped on the one hand with active security devices comprising a microcircuit connected to an antenna that can produce an electromagnetic response when it passes through the electromagnetic field of a contactless reader provided for querying the secure document, characterised in that said support is provided, on the other hand, with passive security devices chosen so as to have electrical properties, in particular, inductive, capacitive and resistive (R, L, C) that can amplify the electromagnetic response of the active security devices to bring it above a threshold that enables the secure document to be identified when it is placed in the electromagnetic field of a contactless reader.

Preferably, the electromagnetic response of the active security devices is also filtered so that the amplified signal, in particular the current induced in the active security devices, is induced within a range of frequencies that is typical of the secure support.

Preferably, the antenna of the active security devices is calculated and arranged so as not to allow the secure document to be recognised by a reader if said passive security devices are missing. In other words, if the associated passive security devices (such as specific printed patterns) are missing, the signal obtained at the terminals of the active security devices in response to the querying signal from the reader can never be enough, regardless mainly of the proximity of the reader, for the identity information contained in the chip to be read. As a consequence, without the specific association on the same support of the original chip and the original passive security devices, the reader can never declare the secure document to be valid.

In a first method of manufacturing the invention, the passive security devices comprise a network of conductive printed patterns on the support, mainly by using conductive inks, and are selected so that the circuit (R, L, C) that they form amplifies the currant induced in the antenna of the active security devices when the document is placed inside the field of a contactless reader, to bring the induced current beyond a threshold required for guaranteeing the operation of the microcircuit of the active security devices.

In an alternative method of manufacturing the invention, the passive security devices comprise a signature box placed on the support, this signature box also having specific electrical (R, L, C) and electromagnetic characteristics. Another alternative method of manufacturing the invention provides, instead of the conductive printed patterns or the signature box, a hologram placed on the support. An even more sophisticated method of manufacturing the invention can include as passive security devices any combination of printed patterns, a signature box and/or a hologram, knowing that the assembly will also have specific R, L, C and electromagnetic characteristics.

In the event of the identity document being made in the form of a standard passport comprising a booklet with a number of pages and possibly with a cover page that is thicker than the internal pages in order to house the chip, it can be provided for the active security devices to be inserted in the first page or in the cover page, and for the passive security devices to be placed on another page, but the opposite arrangement is also possible.

This arrangement puts an end to one typical forging technique in particular, which consists of placing inside the cover of a stolen electronic passport (fitted with an electronic chip) a set of pages with printed patterns taken from another source. Thanks to the invention, a passport with printed patterns without specific R, L, C characteristics that enable the chip to work, cannot be read by the reader and will be considered to be a fake passport.

In an advantageous and compact method of manufacturing the secure document according to the invention, it is presented in the form of a chip card, the active security devices being in the form of a microelectronic module comprising a chip connected to an antenna and built into the body of the chip card, and the passive security devices being placed in an internal layer or in the thickness of the chip card in order to amplify the electromagnetic field passing through the microelectronic module when the chip card is placed in the field of a reader.

The secure document according to the invention may be designed so that the active security devices comprise a microcircuit with no external contacts, the terminals of the microcircuit being connected only to an antenna, which makes it suitable for interacting only with contactless readers.

Alternatively, the active security devices comprise a microcircuit provided with contacts and also connected to an antenna, making the secure document suitable for interacting in contact mode with contact readers or in contactless mode with contactless readers.

Moreover, in the case in which passive security devices are used in the form of printed patterns, it is theoretically possible for the whole of the printed pattern network to be conductive. However, the conductive inks used to print the patterns are relatively expensive. In addition, the electrical resistance of an entirely conductive network of printed patterns would be very high, which would make it difficult to select the other parameters (L, C) in order to obtain satisfying operation. An advantageous alternative consists of selecting only certain printed patterns to be printed in conductive ink. This solution has the double advantage of being less expensive and of further increasing the security, since it will be even more complicated for a forger to determine the characteristics of the network of conductive printed patterns to be copied, since it will not be enough to merely copy the printed patterns that appear visually on the electronic passport.

Another variation of the invention consists of replacing the conductive printed patterns with an antenna integrated in the network of printed patterns as discretely as possible, from a visual point of view, in which case the network of printed patterns is created in the traditional fashion using non-conductive ink.

The invention also relates to an identity verification system comprising at least one reader that works with or without contact, which is able to interact with multiple secure documents such as the above, said reader comprising software means for sending a query signal to each secure document with the aim of verifying the information stored in the chip, in particular identity information.

Further characteristics and advantages of the invention will become apparent from reading the detailed description and the appended drawings, in which:

FIG. 1 shows a secure document with a microchip but without printed patterns, according to the state-of-the-art;

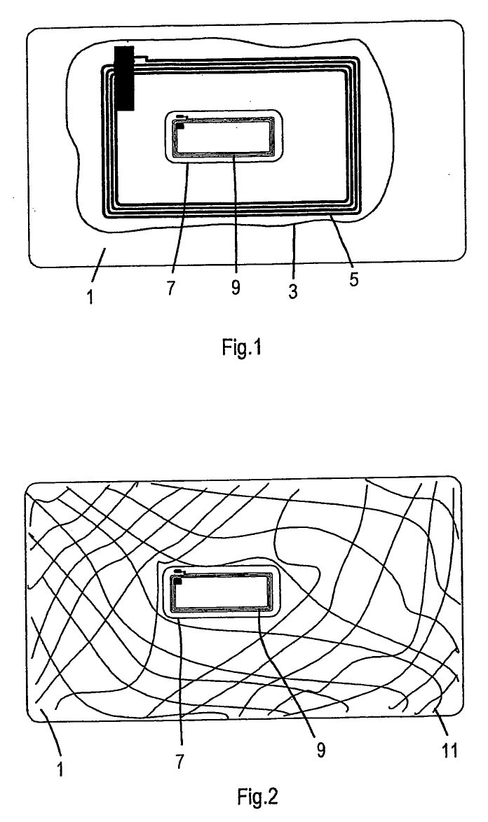

FIG. 2 shows a secure document with a microcircuit identical to that shown in FIG. 1, the top view showing the printed patterns, with a partial cut-away to show the active security devices;

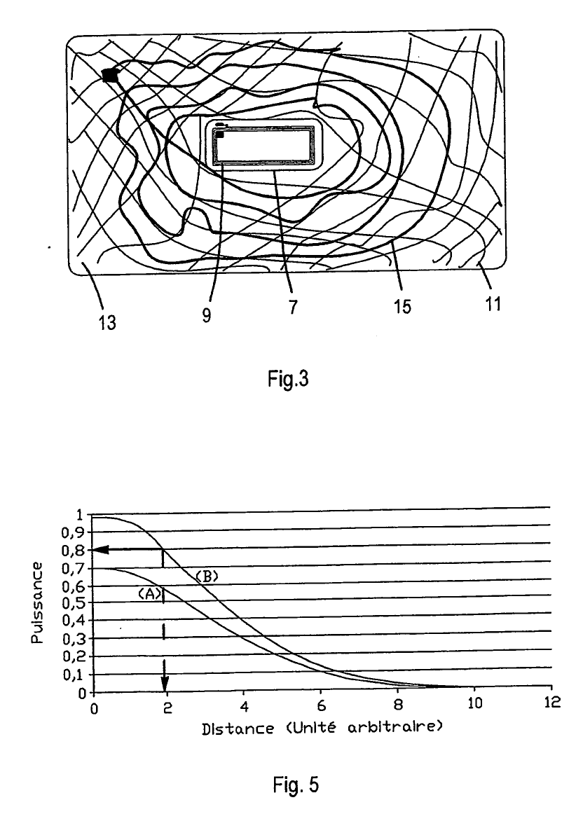

FIG. 3 shows a first method of manufacturing the invention according to the invention;

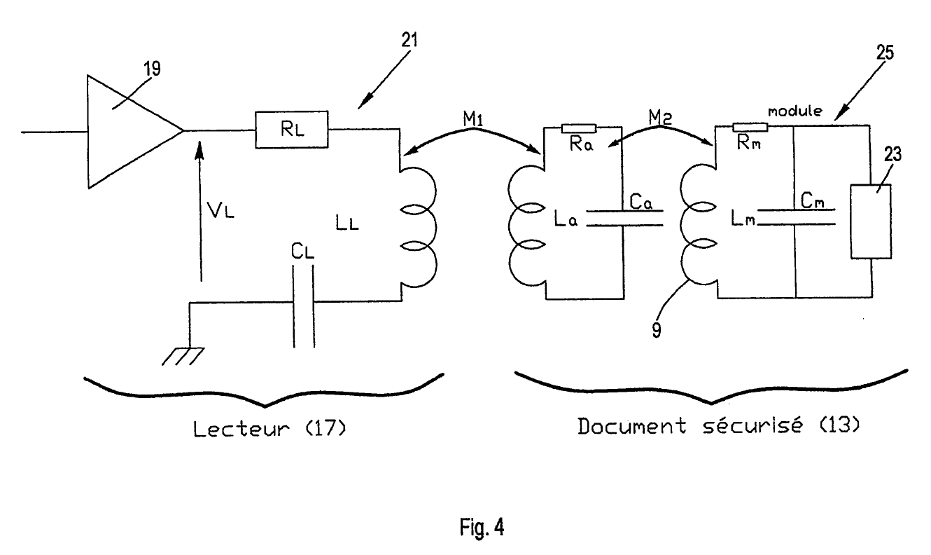

FIG. 4 shows the wiring diagram of a system consisting of a secure document reader and a secure document according to the invention;

FIG. 5 shows, in graphical form, the electromagnetic power reflected by the system in FIG. 4.

The following refers to FIG. 1. This figure shows a schematic diagram of a top view of a secure document 1 known in the state-of-the-art, the document being made in the form of a chip card. The representation includes a partial cut-away 3 to show the layer of the body of the card that comprises the antenna 5. The secure document 1 contains a microelectronic module 7 comprising a chip (not shown), the terminals of which are connected to the terminals of a small antenna 9. Bearing in mind the small dimensions of the antenna 9, the magnetic flux that can be recovered by the antenna 9 when it passes through the magnetic field of a reader, is relatively low, which limits the operating range of the identity document. In order to solve this, there is a known way of adding a larger antenna 5 to the body of the card, which has the effect, as is known, of considerably amplifying, by mutual inductance, the flux captured by the small antenna 9 when the card passes into the field of the reader.

However, it can be seen in this known manufacturing method, that it is rather easy to forge, since it only contains one active security device. All it takes to obtain a functional identity document is to transfer the micromodule 7 removed from another passport, to a forged card, in other words, to a card body personalised with information of the false carrier.

In order to solve this problem and slightly increase the security of the document, it is also known, as shown in FIG. 2, to cover the body of the card 1 with a series of passive visual security devices, such as printed patterns 11. These patterns are printed with non-conductive inks using random mathematical functions in that relating to their shape and layout, as is already known. Not all potential forgers are able to perfect this type of printing, which reduces to a certain extent the risk of fraud. However, in this second variant of the state-of-the-art, there is not always an intimate association between passive security devices such as the printed patterns and active security devices, which include the microelectronic module 7. In fact, they have a simple juxtaposition of devices, without any interaction between them.

The following refers to FIG. 3, which is a schematic representation of the principle of the invention, associated with non-conductive printed patterns, it being understood that this example is in no way exhaustive, since the principle of the invention can be implemented with other types of passive security devices, in particular such as signature boxes, holograms or others, or a combination of said passive security devices. The secure document 13 shown in the form of an electronic passport in chip card format (regardless of whether or not it complies with the ISO 7816 standard), always comprises an electronic module 7 provided with a chip and a small antenna 9 as well as standard printed patterns 11 printed on the body of the card.

According to FIG. 3, an antenna 15 is provided and integrated visually in the network of printed patterns 11 so as to merge with them. It is not electrically connected to any other component; instead, its R, L, C characteristics are used as will be explained in greater detail below. It should be noted that this antenna 15 can advantageously also consist, to fulfil the same function, of certain printed patterns (also marked as 15) with the same specific electromagnetic characteristics.

The antenna or the printed patterns 15 are printed using conductive ink, with colours that make it impossible to tell them apart from the other, non-conductive printed patterns 11 of the printed pattern network. They have specific electrical characteristics of resistance R, inductance L and capacity C, which form an R, L, C circuit which is different from one card type to another. In practice, it is possible, for example, to have the same network of printed patterns for the same customer for all the cards issued over a given range of dates. It is also possible to have a more or less thorough degree of differentiation, according to the application and the security requirements specified by the card issuer.

The following refers to FIGS. 4 and 5 to explain in greater detail the electrical and electromagnetic operation of a system using a reader of secure documents and secure documents according to the invention.

The left-hand side of FIG. 4 shows the wiring diagram of a contactless reader 17. It comprises, in a known fashion, an amplifier 19 that delivers to a circuit (R, L, C) 21 a signal sent to a secure electronic document. In principle, the signal can be an order to read information saved in the memory of the secure document, or a write signal. However, it is understood that in a standard security application, the reader 17 sends a read signal to the secure document 13 to verify its authenticity and that it perfectly matches the carrier of the document. The right-hand side shows the wiring diagram of a secure document 13 according to the invention. It comprises active secure devices in the form of a microelectronic chip 23 comprising at least one memory in which the information to be read by the reader is saved. At least one of the circuits of this chip, typically its supply circuit, is connected to a circuit Rₘ, Lₘ, Cₘ acting as an antenna. The Rₘ, Lₘ, Cₘ characteristics are selected so that regardless of the distance between the secure document 13 and the reader 17, in other words even if this distance is nil or almost nil, the current induced by the reader in the supply circuit of the chip 23 is not enough to activate the chip and make it operate in read or write mode.

These active security devices 23, 25 are associated with passive security devices 27 in the form of a magnetic field amplifier, which have electrical characteristics, Rₐ, Lₐ, Cₐ, selected so as to considerably amplify, by mutual inductance marked as M2, the electromagnetic read or write signal coming from the reader 17 by means of the M1 connection. In this way, a current that is stronger than the minimum current needed for the chip to work then circulates in the supply circuit 25 of the chip 23.

It should be noted that due to the operating characteristics of the Rₐ, Lₐ, Cₐ circuits, amplification by the field amplifier 27 is accompanied by frequency filtering, so that it becomes possible to set the peak amplitude of the field or current induced within a typical range of frequencies, due to the connection with the passive security devices. Thus, only the electromagnetic connection of fully matching active (23, 25) and passive (27) security devices will be able to increase the current induced in the passive security devices beyond its operating threshold, and therefore be able to make a given security document work.

FIG. 5 shows a curve that represents the electromagnetic power reflected by the secure document 13, for example the curve of intensity of the current induced in the power supply circuit of the chip 23, according to the distance to the reader 17, measured in arbitrary units. The representation is made without amplification of the magnetic field (curve A) and with amplification of the magnetic field (curve B). Curve A shows that, regardless of the proximity of the secure document to the reader, the intensity of the induced current will always be weaker than the threshold S that allows the chip 23 to work. On the other hand, curve B shows that, thanks to amplification, there are areas (in the example shown, those in which the distance between the reader and the secure document is less than two units of distance) in which the induced current is stronger than the minimum threshold S, which makes it possible to activate the chip and make it work.

Each set of specific printed patterns 15 is calculated so as to amplify the electromagnetic field of the reader 17 of an identification system within a specific range of frequencies, which has the effect of amplifying and filtering the flux which is used by the antenna 9 of the micromodule 7. Preferably, the antenna circuit 9 of the module 7 is calculated so that the flux issuing from the single current induced in the antenna 9, when the conductive printed patterns 15 are missing, does not make it possible to “awaken” the chip of the micromodule 7 and to read it. On the other hand, the printed patterns 15 are calculated, by the skilled worker, from the point of view of their size and their layout, to constitute an electronic circuit that is such that the field they recover makes it possible, by mutual induction M2, to considerably amplify the current induced in the antenna, within a given range of frequencies. This amplification makes it possible to bring the field and therefore the induced current, beyond a threshold, which makes it possible to “awaken” the micromodule 7 in its associated range of operating frequencies, and in this way to communicate with the chip by reading or writing.

The following is a more detailed description of the role and operation of the magnetic field concentrator or amplifier provided by the passive circuit R, L, C, which consists of the passive security devices 27.

The magnetic field amplifier is defined so as to have a resonance frequency that is very similar or identical to the resonance frequency of the RFID system (Radiofrequency Identification) to which it will be connected.

The following formula provides a definition of the R, L, C values:

Fr=1/(2*Pl*√(L·C)

in which Fr designates the resonance frequency, L the inductance and C the capacity of the passive circuit, which consists of the printed patterns 15 in this example.

More precisely, these R, L, C values are calculated in a way known to the skilled worker, so that the couple formed by the magnetic field amplifier 27 and the microelectronic module 7 with its antenna 9 resonates at the working frequency of the radiofrequency transmitters of the contactless reader that allow the system to work or at a similar frequency.

This magnetic field amplifier system generates in its surrounding area a very high concentration of electromagnetic fluxes at the working frequency. The microelectronic module 7 (also referred to sometimes as a “chip”) located near this field amplifier can therefore be activated by a stronger field than if it was on its own, and the system as a whole is therefore more efficient in terms of operating distance, or else it can work with a field issued by the weaker reader.

The following is a more detailed description of a method of manufacturing the passive circuit R, L, C once it has been calculated. An example of this is the case in which the passive circuit 27 contains printed patterns 15 made in electrically conductive ink, it being assumed that the manufacturing method can be easily transposed by the skilled worker to other manufacturing methods, in which the passive security devices used are not printed patterns.

The electrical capacity C is advantageously provided by stacking three layers of material, namely a conductive layer including the printed pattern that acts as an antenna, an insulating layer made from a material with known permittivity and a conductive layer that makes it possible to connect the various printed patterns among each other.

A simple calculation makes it possible, according to the surface of the opposing conductive layers, the thickness of the insulator separating them and the permittivity of the insulating layer, to define the R, L, C characteristics provided by such a manufacturing method.

In a variant on this invention in which the secure document is a card with a double contact and contactless communication interface, the electronic module 7 comprises on its top face a terminal board for connection by contact and on its bottom face an antenna connected to the chip 23, the passive security device 27 being located inside the body of the card and constituting a circuit that is dedicated to concentrating or amplifying the electromagnetic flux coming from the reader and to directing it towards the microelectronic module 7 comprising the two communication interfaces. In this variant, the passive security device 27 is located opposite the double-interface module and surrounds at least three sides of said module.

Furthermore, the position of the chip forming the microelectronic module is defined according to the mechanical constraints that affect the identity document, as is already known. The microelectronic module 7 is preferably positioned at a distance from the centres of mechanical stress to which the finished product is subjected. In addition, to manufacture the actual chip, any known method can be used, such as that described in patent application FR 05-01378, in the name of the applicant.

The same method is applied in the manufacturing method in which the passive security devices comprise an antenna 15 integrated as discretely as possible, or even invisibly, in a network of printed patterns 11 made from non-conductive ink. In a known fashion, a computer-assisted manufacturing file is created to make it possible to view these printed patterns using a printed pattern generating software. Then, based on the calculations of the magnetic amplifier which provide mainly the inductance value L of the antenna of the magnetic amplifier, the geometry of the antenna is defined using a coil with a thickness that is identical to the thickness of the printed pattern so that the antenna is invisible or almost invisible among the network of printed patterns. Using an image generating software application, this antenna is then drawn so as to integrate perfectly with the network of printed patterns from a visual point of view.

Then, the surfaces of the layers that enable the creation of the capacitive element of the passive security devices are defined, and the element is drawn as above, in order to integrate visually with the antenna and the printed patterns.

Still using the graphic-generation software application, this image is then separated into layers for printing:
one layer for the printed patterns which will be printed using standard ink
one layer for the first layer of conductive ink of the magnetic amplifier
one layer for depositing the insulator of the capacitive element of the magnetic amplifier
and, finally, a layer for the second conductive deposit of the magnetic amplifier.

These various layers or masks of the image file thus created make it possible to create the forms used for manufacturing (offset film, silk-screen, etc. according to the choice made).

The last operation prior to manufacturing is the selection of ink colours. The conductive inks chosen for the passive security elements 27 will preferably be similar colours to the inks used for the non-conductive printed patterns 11.

A method often used for offset printing of the printed patterns is to use different-coloured inks placed in different locations of the same ink fountain of the printing press. This provides a partial mix at certain points of the ink fountain and thus on the document, with a graded effect between two or three colours. In the event of using this printing method, the colours used for the conductive and non-conductive inks must be identical and placed identically in the two ink fountains.

In order not to affect the graphic effects, the chosen insulating ink will preferably be transparent.

In order to further increase the difficulty of visually locating the passive security elements 27, they can be made using transparent, conductive ink, with an intrinsically transparent polymer base.

This invention has many advantages with regard to current identity documents. The invention enables a considerable increase of the resistance of existing secure documents, such as identity documents, to forging attempts. In particular, if the secure document is opened or taken apart, the electronic module 23 cannot work of its own accord, since it would be deprived of the passive secure devices 27 with which it is associated. In fact, the passive security devices are intimately and functionally linked to the electrical operation of the active security devices of the document. For example, if the active micromodule is removed from the field of the printed patterns, it does not emit any more signals, even when placed in the field of the reader. The fact that the printed patterns and the magnetic fields they emit are specific to each identity document or each type of identity document, means that each radiofrequency identification device cannot be separated from its identity document, at the risk of becoming inactive. This is a high level of security.

In addition, the physical or graphical security is closely linked to the electronic security of the document. It is even more difficult for this type of document to be forged. It would be necessary, in fact, to copy the specific circuit of connections in a document, which would consist of emulating the electromagnetic effect of the passive security devices such as the conductive printed patterns.

In addition to the preceding security advantages, a further advantage is added when personalising secure documents, since graphical and electronic personalisation sites, often separate, can be a target for burglars. If they are stolen, it is futile to try to assemble the passive security devices according to the invention, since the assembly of such components, which are not designed to work together, will not be able to work.

1-14. (canceled)

15. A secure document, comprising a support provided with active security devices that can produce an electromagnetic response when the secure document passes through the electromagnetic field of a contactless reader designed to query said document, said support further being provided with passive security devices which can interact with the active security devices, wherein the active security devices are associated with passive security devices which are specific and variable from one document to another, in order to make the secure document functional only when the secure document is placed in the electromagnetic field of a contactless reader and when said active security devices and passive security devices are both present.

16. The secure document according to claim 15, wherein the active security devices comprise a microcircuit connected to an antenna that can produce an electromagnetic response when it passes through the electromagnetic field of a contactless reader, and the passive security devices are selected so as to have inductive, capacitive and/or resistive characteristics that are able to amplify the electromagnetic response of the active security devices beyond a threshold that enables the identification of the identity document when it is placed in the electromagnetic field of the contactless reader.

17. The secure document according to claim 16 said passive security devices comprise a network of conductive printed patterns printed on the support, and selected so that the circuit they form amplifies the current induced in the antenna of the active security devices when the secure document is placed in the field of a contactless reader beyond a threshold required to guarantee the operation of the microcircuit of the active security devices.

18. The secure document according to claim 15, wherein the passive security devices comprise an antenna which has its coils invisibly integrated in a network of printed patterns printed using non-conductive ink.

19. The secure document according to claim 15, wherein the passive security devices comprise a signature box placed on the support.

20. The secure document according to claim 15, wherein said passive security devices comprise a hologram placed on the support.

21. The secure document according to claim 15, wherein the passive security devices comprise at least one of an antenna, conductive printed patterns, a signature box and a hologram.

22. The secure document according to claim 15, wherein said secure document comprises a passport booklet with multiple pages, and wherein the active security devices are inserted in a first page or cover page, with the passive security devices being placed on a different page.

23. The secure document according to claim 15, wherein the secure document comprises a chip card, the active security devices being of a microelectronic module comprising a chip connected to an antenna and built into the body of the chip card, and the passive security devices being placed in the thickness of the chip card in order to substantially amplify the electromagnetic field passing through the microelectronic module when the chip card is placed in the field of a reader.

24. The secure document according to claim 15, wherein the active security devices comprise a microcircuit with no external contacts but which is connected to an antenna, which makes it able to interact exclusively with contactless readers.

25. The secure document according to claim 15, wherein the active security devices comprise a microcircuit equipped with contacts even though it is connected to an antenna, enabling the secure document to interact in contact mode with contact readers or in contactless mode with contactless readers.

26. The secure document according to claim 17, wherein only certain specific printed patterns of the network of printed patterns are conductive and therefore a part of the passive security devices.

27. An identity verification system comprising at least one reader, which is contactless or works by contact, that can interact with multiple identity documents, said reader including a software program for sending a query signal to each identity document to verify identity information stored in the identity document, wherein the identity document is a secure document according to claim 15.
